(19) United States
(12) Patent Application Publication
(10) Pub. No.: US 2009/0089589 A1
(43) Pub. Date: Apr. 2, 2009

(54) INFORMATION PROCESSING APPARATUS FOR PROTECTED DATA FILES AND INFORMATION PROCESSING METHOD THEREOF

(75) Inventor: Yoshikata TOBITA, Fuchu-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/237,269

(22) Filed: Sep. 24, 2008

(30) Foreign Application Priority Data
Sep. 28, 2007 (JP) 2007-256620
Feb. 20, 2008 (JP) 2008-039125

(51) Int. Cl. H04L 9/06; G06F 17/30; G06F 12/14; H04L 9/00

(52) U.S. Cl. 713/190; 713/189; 707/205

(57) ABSTRACT

According to one embodiment, a processing environment of protected file data is improved by an inspection module which inspects whether file ARF protected in a predetermined format is usable or unusable, an information table in which usable/unusable data of the ARF is set based on the inspection result of the inspection module, a file cache which stores the ARF, the usable/unusable data of which is set in this table, and a decryption processor which decrypts resource data as the contents of an encrypted data object using the ARF stored in this cache.

### CROSS-REFERENCE TO RELATED APPLICATIONS

This application is based upon and claims the benefit of priority from Japanese Patent Applications No. 2007-256620, filed Sep. 28, 2007, and No. 2008-039125, filed Feb. 20, 2008, the entire contents of which are incorporated herein by reference.

### BACKGROUND

1. Field

One embodiment of the present invention relates to an information processing apparatus and information processing method, which process protected file data in advanced digital video playback.

2. Description of the Related Art

Nowadays, DVD (Digital Versatile Disc)-Video has widely prevailed. Also, Advanced Video that handles both a standard content as an expansion of this conventional DVD-Video and an advanced content that greatly modifies the conventional DVD-Video begins to be put on the market, and is going to be prevalent. In this Advanced Video, as related arts associated with processing of information protected from illicit use and the like, the following documents are available:

(1) Japanese Patent Application Publication No. 2001-211151 (see FIGS. 2 and 22): This document relates to a data processing apparatus which verifies for respective blocks whether or not data encrypted in a CBC mode is falsified, and stores and plays back the result in a recording device. In this apparatus, when the result is bad, storage and playback are aborted. However, in this document, a disclosure about an information table indicating whether protected files are usable or unusable, and a disclosure about handling of the information table when a key used to decrypt protected data is switched are not found.

(2) Japanese Patent Application Publication No. 2004-295373 (see FIG. 1): This document relates to an information recording medium and apparatus, which store encryption key information needed for encrypted contents, and a revocation list of information recording media which are determined as unauthorized media, and eliminate illicit copies.

(3) Japanese Patent Application Publication No. 2002-132141 (see FIG. 34): This document relates to a data storage apparatus, which adopts a configuration in which data as a result of encryption in a CBC mode is stored in a header corresponding to a content, so as to enhance the security.

With the techniques disclosed in these documents, upon playing back protected data, if the size of this data is large, a time period from when that data is going to be used until it is actually ready to use is long. Also, with the techniques disclosed in the above documents, it is also difficult to reduce the file cache size needed to process protected files.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram for explaining an example of the arrangement of an information processing apparatus according to one embodiment of the invention;

FIG. 2 is an exemplary view for explaining an example of the configuration of information table 105a shown in FIG. 1;

FIG. 3 is an exemplary view showing an example of the data structure of an object used in one embodiment of the invention;

FIG. 4 is an exemplary view for explaining the data structure of an advanced packet used in one embodiment of the invention;

FIG. 5 is an exemplary view for explaining an example (ARF first format) of the data structure of a resource file used in one embodiment of the invention;

FIG. 6 is an exemplary view for explaining another example (ARF second format) of the data structure of a resource file used in one embodiment of the invention;

FIG. 7 is an exemplary view for explaining still another example (ARF third format) of the data structure of a resource file used in one embodiment of the invention;

FIG. 8 is an exemplary view for explaining yet another example (ARF fourth format) of the data structure of a resource file used in one embodiment of the invention;

FIG. 9 is an exemplary flowchart for explaining an information processing method according to the first embodiment of the invention;

FIG. 10 is an exemplary flowchart for explaining an information processing method according to the second embodiment of the invention;

FIG. 11 is an exemplary flowchart for explaining an information processing method according to the third embodiment of the invention;

FIG. 12 is an exemplary flowchart for explaining an information processing method according to the fourth embodiment of the invention;

FIG. 13 is an exemplary flowchart for explaining an information processing method according to the fifth embodiment of the invention;

FIG. 14 is an exemplary view for explaining the relationship of files associated with falsification verification; and

FIG. 15 is an exemplary flowchart for explaining an example of falsification verification.

### DETAILED DESCRIPTION

Various embodiments according to the invention will be described hereinafter with reference to the accompanying drawings. In general, according to one embodiment of the invention, an information processing apparatus uses one or more files (ARF) protected in a predetermined format. This apparatus comprises an inspection module (110) which inspects whether the one or more files (ARF) are usable or unusable, an information table (105a) in which usable/unusable data about the one or more files (ARF) are set based on the inspection result of the inspection module, a file cache (105) which stores the one or more files (ARF), the usable/unusable data of which are set in the information table (105a), and a decryption processor (109) which decrypts the contents (resource data) of an encrypted data object (encrypted P-EVOB) using the one or more files (ARF) stored in the file cache (105).

An information processing method according to another embodiment of the invention comprises: inspecting whether one or more files (ARF) protected in a predetermined format are usable or unusable (ST102, ST108, etc.); setting usable/unusable data about the one or more files (ARF) in an information table (105a) based on the inspection result of an inspection module (ST104, ST110, etc.); storing, in a file cache (105), the one or more files (ARF), the usable/unusable data of which are set (ST112, etc.); and decrypting the contents (resource data) of an encrypted data object (encrypted P-EVOB) using the stored one or more files (ARF) (ST130, etc.)

In a playback scene of Advanced Video (such as the contents of an encrypted data object) or the like, one or more protected files (ARF) are stored in advance together with their usable/unusable information prior to the beginning of object playback. For this reason, at the beginning of object playback, use of needed files (ARF) can be started immediately.

One aspect of the invention is to improve a processing environment of protected file data (e.g., to shorten a time needed, to reduce a needed file cache size, and so forth).

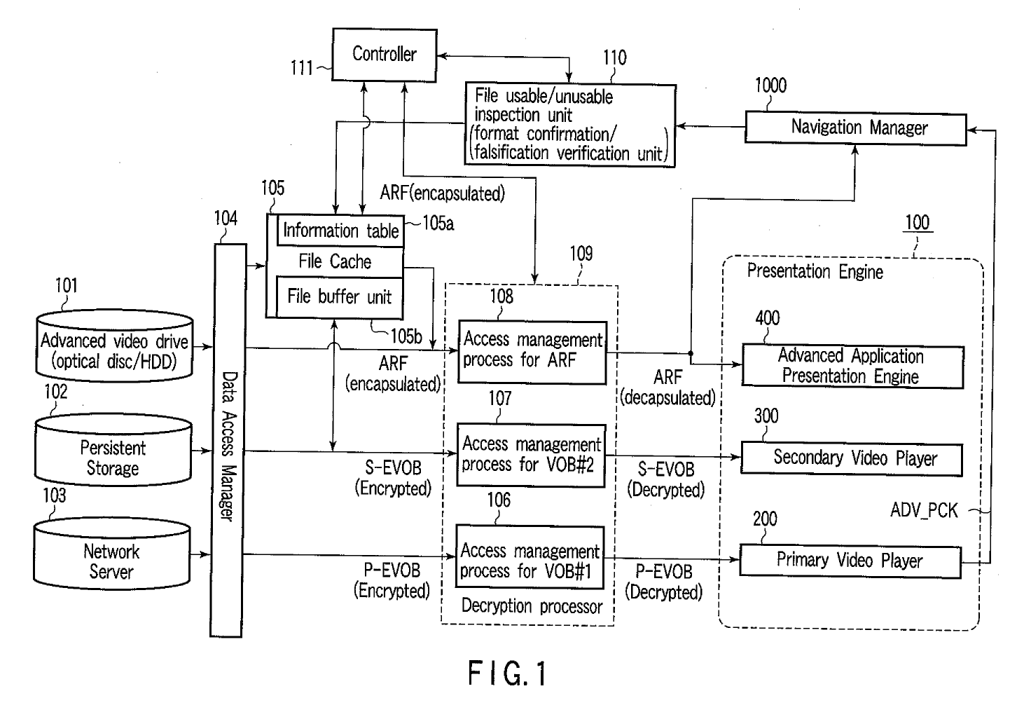

An information processing apparatus and information processing method according to various embodiments of the invention will be described hereinafter with reference to the drawing. FIG. 1 is a block diagram for explaining an example of the arrangement of an information processing apparatus according to an embodiment of the invention. FIG. 1 exemplifies a system model of an Advanced Video player according to an embodiment of the invention. Referring to FIG. 1, reference numeral 101 denotes an advanced drive (optical disc drive and/or hard disc drive); 102, a persistent storage; and 103, a network server. Data streams from advanced drive 101, persistent storage 102, and network server 103 are input to data access manager 104.

Each data stream input to data access manager 104 includes information of an advanced content. This advanced content includes a playlist, primary video set, secondary video set, advanced application, and advanced subtitle. The playlist is information used to manage playback objects such as the primary video set, secondary video set, advanced application, advanced subtitle, and the like.

The primary video set (or advanced video title set) includes video title set information (attribute information), time map information, and a primary enhanced video object (to be abbreviated as needed as a P-EVOB hereinafter). The secondary video set includes time map information and a secondary enhanced video object (to be abbreviated as needed as an S-EVOB hereinafter).

The advanced application includes advanced navigations such as a manifest, markup, script, and the like, and advanced elements such as JPEG (Joint Photograph Expert Group), PNG (Portable Network Graphics), MNG (Multiple-image Network Graphics), LPCM (Linear PCM), Open Type, and the like. The advanced subtitle is a subset of the advanced application, and includes a manifest, markup, and advanced elements (JPEG, PNG, Open Type, and the like).

An encrypted P-EVOB stream included in one of the data streams input from advanced drive 101, persistent storage 102, and network server 103 to data access manager 104 is decrypted via P-EVOB access management processor 106, and the decrypted P-EVOB stream is sent to primary video player (data presentation processor) 200.

An encrypted S-EVOB stream included in one of the data streams input from advanced drive 101, persistent storage 102, and network server 103 to data access manager 104 is sent to a streaming buffer (not shown) included in file cache 105. Also, the encrypted S-EVOB stream is decrypted by S-EVOB access management processor 107, and the decrypted S-EVOB streams are sent to secondary video player 300.

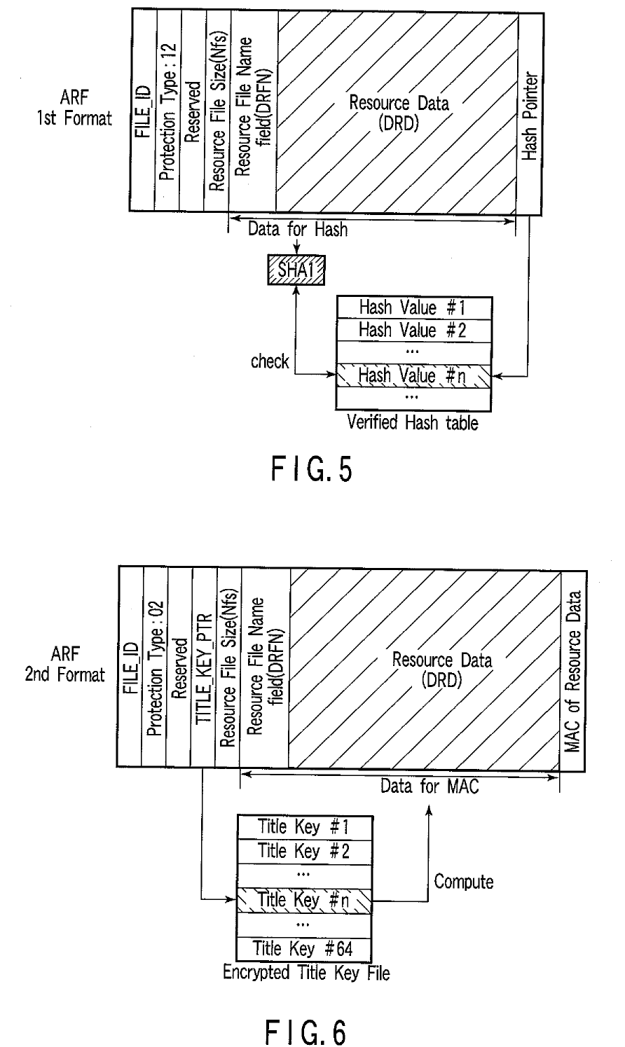

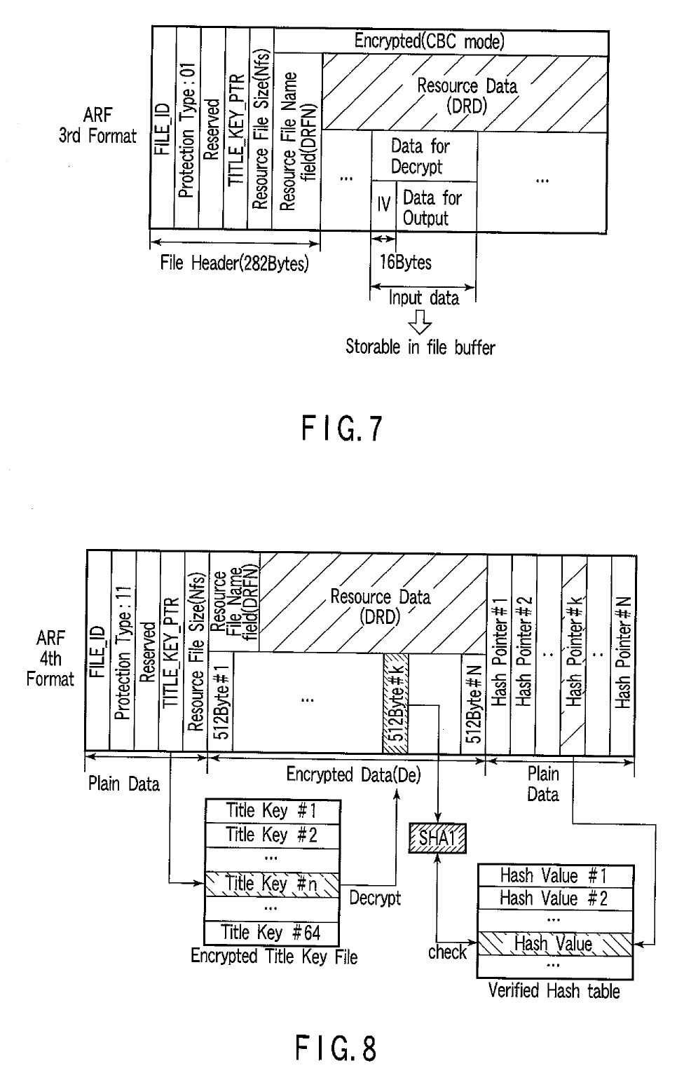

File data (ARF protected by access management) other than the P-EVOB and S-EVOB included in one of the data streams input from advanced drive 101, persistent storage 102, and network server 103 to data access manager 104 are stored in file cache 105. This file cache 105 can store advanced resource files ARF (see FIGS. 5 to 8) from a file cache manager (not shown) in navigation manager 1000. File cache 105 includes information table 105a (to be described later) and file buffer module 105b. File buffer module 105b can comprise a buffer with a relatively small fixed size (e.g., as small as 512 bytes or multiples of 512 bytes), which is not guaranteed to be larger than the total size of one or more ARFs (see FIG. 7 or 8).

A data stream of an advanced resource file (to be abbreviated as needed as an ARF hereinafter) including information such as advanced elements, fonts, advanced subtitles, and the like of the file data stored in file cache 105 and/or an encapsulated ARF included in one of the data streams input from advanced drive 101, persistent storage 102, and network server 103 to data access manager 104 is decapsulated via ARF access management processor 108. Then, the decapsulated ARF data stream is sent to advanced application presentation engine 400. Access management processors 106 to 108 configure decryption processor 109. Primary video player 200, secondary video player 300, and advanced application presentation engine 400 configure presentation engine 100. Note that access management can use a known encryption technique.

Primary video player (data presentation processor) 200 extracts advanced packs (to be abbreviated as needed as ADV_PCKs hereinafter) from the P-EVOB data stream. The extracted ADV_PCKs or advanced packets (to be abbreviated as needed as ADV_PKTs hereinafter) included in those packs are transferred to navigation manager 1000. Navigation manager 1000 controls all function modules of the advanced content player with the arrangement shown in FIG. 1, and also controls user interfaces via a remote controller (not shown), a front panel of the player, and the like.

The file cache manager (not shown: described above) in navigation manager 1000 sends the ARF from access management processor 108 to file usable/unusable inspection module 110. This inspection module 110 executes format confirmation and/or falsification verification of the received ARF. More specifically, a format confirmation unit of inspection module 110 confirms to which of formats shown in FIGS. 5 to 8 the received ARF corresponds. A falsification unit of inspection module 110 executes falsification verification of the ARF using a verified Hash table (FIG. 5) or M*A*C (Message*Authentication*Code) calculation values (FIG. 6) to see whether or not the received ARF has been falsified. The encapsulated ARF after the format confirmation/falsification verification is sent to information table 105a in file cache 105. Note that processing of an ARF file in file cache 105, decryption processor 109, file usable/unusable inspection module 110, and the like is controlled by firmware of controller (comprising a microcomputer) 111.

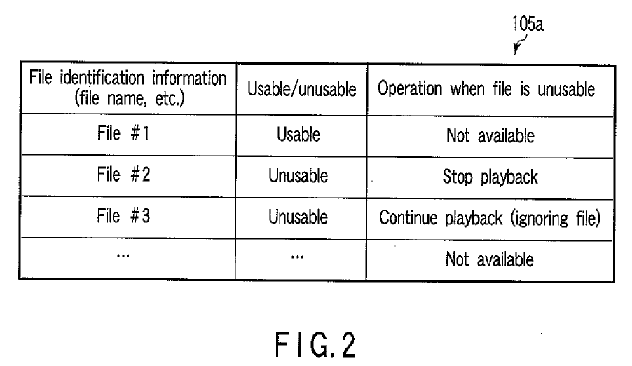

FIG. 2 is a view for explaining an example of information stored in information table 105a in FIG. 1. FIG. 2 exemplifies an ARF (a file name in this example is file #1) which is determined to be usable by format confirmation and/or falsification verification in inspection module 110, an ARF (a file name in this example is file #2) which is determined to be unusable, an ARF (a file name in this example is file #3) which is determined to be unusable, and the like. Information table 105a of this example is configured to describe not only usable/unusable data of corresponding files but also operations to be executed by the player if a corresponding file is unusable (e.g., to stop playback, to continue the playback operation by ignoring the corresponding file, and so forth), as needed.

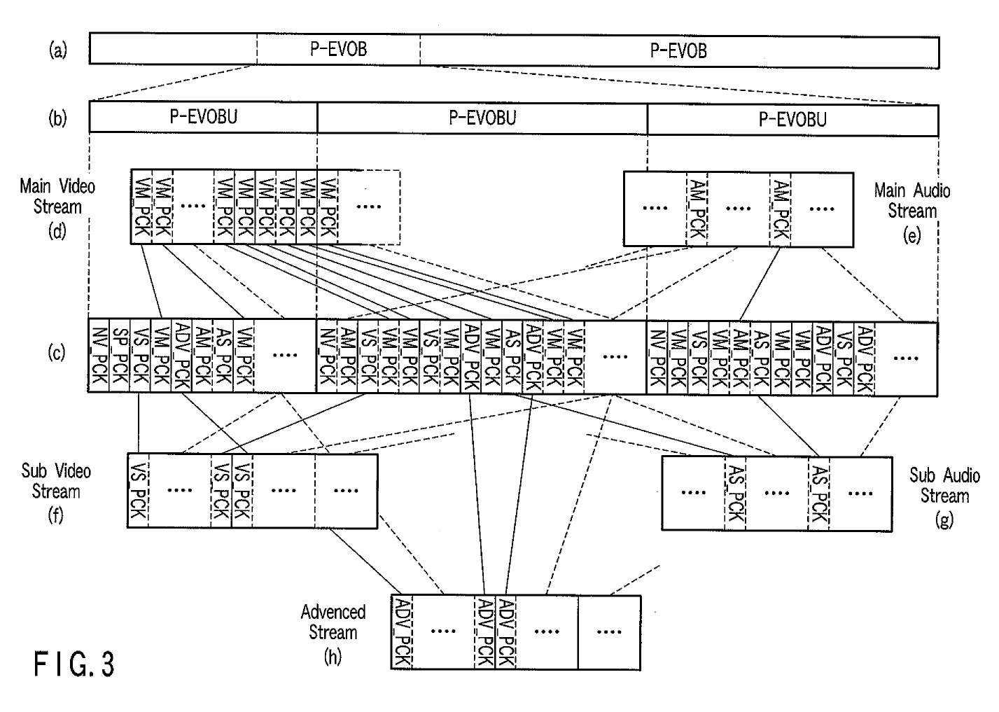

FIG. 3 is a view for explaining an example of the data structure of an object used in the embodiment of the invention. A P-EVOB (FIG. 3(a)) input to primary video player 200 includes one or more primary video object units (to be abbreviated as needed as P-EVOBUs hereinafter) each serving as a data access unit (FIG. 3(b)). Each E-EVOBU (FIG. 3(c)) has a navigation pack (to be abbreviated as needed as an NV_PCK hereinafter) at its head position, and includes a plurality of types of data packs (sub-picture pack SP_PCK, sub video pack VS_PCK, main video pack VM_PCK, advanced pack ADV_PCK, main audio pack AM_PCK, sub audio pack AS_PCK, etc.) after the NV_PCK. Each P-EVOBU has a predetermined size ranging from 0.4 sec to 1.001 sec as a unit of a presentation time. In other words, a plurality of P-EVOBUs are arranged at constant or predetermined intervals. The boundary between two successive P-EVOBUs can be detected by reading the NV_PCK located at the head position of each P-EVOBU.

Of the plurality of types of data packs included in respective P-EVOBUs, a set of VM_PCKs forms a main video stream (FIG. 3(d)), a set of AM_PCKs forms a main audio stream (FIG. 3(e)), a set of VS_PCKs forms a sub video stream (FIG. 3(f)), a set of AS_PCKs forms a sub audio stream (FIG. 3(g)), and a set of ADV_PCK forms an advanced stream (FIG. 3(h)). In the arrangement of FIG. 1, when the advanced stream in FIG. 3(h) is extracted from the data stream in FIG. 3(a), ADV_PCKs in this advanced stream are transferred to advanced pack processor 205 for respective units each including a certain number of ADV_PCKs via any of a plurality of reception buffers #1 to #N.

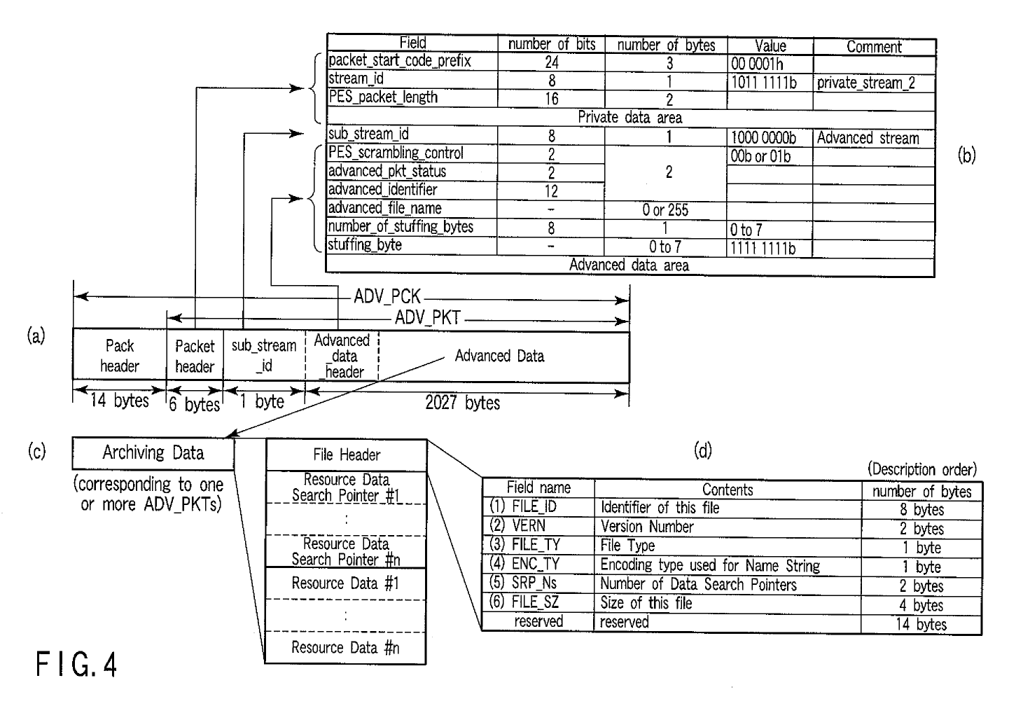

FIG. 4 is a view for explaining the data structure of an advanced packet (ADV_PCK) used in the embodiment of the invention. Each ADV_PCK includes a pack header and advanced packet (ADV_PKT) (FIG. 4(a)). Each ADV_PKT includes a packet header including a stream identifier (stream_id), a sub stream identifier (sub_stream_id) indicating that the data stream of interest is an advanced stream, an advanced data header (advanced_data_header), and advanced data.

Note that the advanced data header includes information such as position information (advanced_pkt_status) of the ADV_PKT in the advanced stream, an identifier (advanced_identifier) of a plurality of archiving files that may exist, and a file name (advanced_file_name) of an archiving file configured by the packet of interest (FIG. 4(b)).

The advanced data included in one or more ADV_PKTs corresponds to archiving data (FIG. 4(c)). This archiving data includes a file header, one or more resource data search pointers #1 to #n, and one or more resource data #1 to #n pointed by resource data search pointers #1 to #n. These resource data #1 to #n may have a relatively large total size.

The file header includes information such as a file identifier (FILE_ID) of the archiving data of interest, a version (VERN) of the standard of interest, a file type (FILE_TY) indicating whether or not the file of interest is compressed data, a text encode type (ENC_TY) used in a resource name string, the number (SPR_Ns) of data search pointers, a size (FILE_SZ) of the file of interest, and the like (FIG. 4(d)).

Resource data #1 to #n carried by a plurality of ADV_PCKs are encrypted one by one by access management. The archiving data including such resource data is processed in navigation manager 1000 in FIG. 1, and ARFs corresponding to these resource data are sent to inspection module 110 via the file cache manager (not shown) in navigation manager 1000. The inspection result (usable/unusable, etc.) of each encapsulated ARF after inspection is written in information table 105a, and is returned to and stored in file cache 105.

FIG. 5 is a view for explaining an example (ARF first format) of the data structure of a resource file (ARF) used in the embodiment of the invention. In this example, an ARF file header includes a FILE_ID, protection type: 12 (type using Hash values), a resource file size (Nfs), and a resource file name field (DRFN). After this header, resource data (DRD) and a Hash pointer are allocated. The ARF first format in FIG. 5 can be confirmed using, e.g., the FILE_ID and Protection type: 12, or format identification information (not shown) in a reserved area.

In this ARF first format, the DRFN and DRD are used as data for Hash. In this format, a verified Hash table is separately prepared. When the Hash pointer after the DRD points to, e.g., Hash value #n in the verified Hash table, whether or not the ARF is falsified can be verified by comparing Hash value SHA1 calculated from the data for Hash with Hash value #n and checking if the two values match. Note that the file header of the ARF is different from that of the archiving data (FIG. 4(c)).

FIG. 6 is a view for explaining another example (ARF second format) of the data structure of a resource file (ARF) used in the embodiment of the invention. In this example, an ARF file header includes a FILE_ID, protection type: 02 (type using a M*A*C value), pointer TITLE_KEY_PTR indicating an encryption key, a resource file size (Nfs), and a resource file name field (DRFN). After this header, resource data (DRD) and a M*A*C of resource data (Message*Authentication*Code of resource data) are allocated. The ARF second format in FIG. 6 can be confirmed using, e.g., the FILE_ID and protection type: 02, or format identification information (not shown) in a reserved area.

In this ARF second format, the DRFN and DRD are used as data for M*A*C. In this format, an encrypted Title*Key*File is prepared. When the TITLE_KEY_PTR points to, e.g., TITLE_KEY #n of the encrypted Title*Key*File, whether or not the ARF is falsified can be verified by comparing a M*A*C value calculated from TITLE_KEY #n with a M*A*C expected value stored in the ARF, and checking if the two values match.

FIG. 7 is a view for explaining still another example (ARF third format) of the data structure of a resource file (ARF) used in the embodiment of the invention. In this example, an ARF file header includes a FILE_ID, protection type: 01 (type using a CBC mode), pointer TITLE_KEY_PTR indicating an encrypted key, a resource file size (Nfs), and an encrypted resource file name field (DRFN). After this header, encrypted resource data (DRD) is allocated.

The ARF third format in FIG. 7 can be confirmed using, e.g., the FILE_ID and protection type: 01, or format identification information (not shown) in a reserved area.

The ARF third format uses the CBC mode for encryption. In the encrypted DRD, a 16-byte initial vector (IV) is allocated at the head position, and the subsequent field can be segmented into blocks of data for decrypt having output data. In this example, the segmented data blocks for decrypt can be used as input data to file buffer module 105b shown in FIG. 1. Each segmented data block for decrypt can have a relatively small size, e.g., 512 bytes.

Note that the CBC mode is specified by the Data Encryption Standard. In this CBC mode, data #1*, which is encrypted by an exclusive logical sum EXOR of the initial value, i.e., the initial vector (IV) and data #1 encoded by the AES (Advanced Encryption Standard), is generated, and data #2*, which is encrypted by an EXOR of generated data #1* and AES-encoded data #2, is generated. Likewise, data #n*, which is encrypted by an EXOR of the generated data #(n−1)* and AES-encoded data #n, is generated. In this manner, encrypted data #1* to #n* can be generated from data #1 to #n using the specific IV. Conversely, if the IV used in encryption is given, decrypted data #n to #1 can be obtained from data #n* to #1* in a process opposite to encryption. This process is known.

FIG. 8 is a view for explaining yet another example (ARF fourth format) of the data structure of a resource file (ARF) used in the embodiment of the invention. In this example, an ARF file header includes a FILE_ID, protection type: 11 (type using a title key and Hash values), pointer TITLE_KEY_PTR indicating an encryption key, a resource file size (Nfs), and an encrypted resource file name field (DRFN). After this header, encrypted resource data (DRD) and Hash pointers #1 to #N are allocated. The ARF fourth format in FIG. 8 can be confirmed using, e.g., the FILE_ID and protection type: 11, or format identification information (not shown) in a reserved area.

In the ARF fourth format, data from the FILE_ID to resource file size (Nfs) and Hash pointers #1 to #N are set as non-encrypted plain data, and the resource file name field (DRFN) and resource data (DRD) are set as encrypted data (De). The encrypted data (De) are segmented into N data blocks each having a relatively small size, e.g., 512 bytes. In this manner, each individual data block can be handled by small file buffer module 105b in FIG. 1.

In the example of FIG. 8, a Title*Key in an encrypted Title*Key*File is used in encryption of the encrypted data (De), and 512-byte data blocks are used in falsification verification of the ARF based on Hash values. In this example, since the data size used in Hash value calculation is small, the arithmetic process time needed for falsification verification can also be shortened.

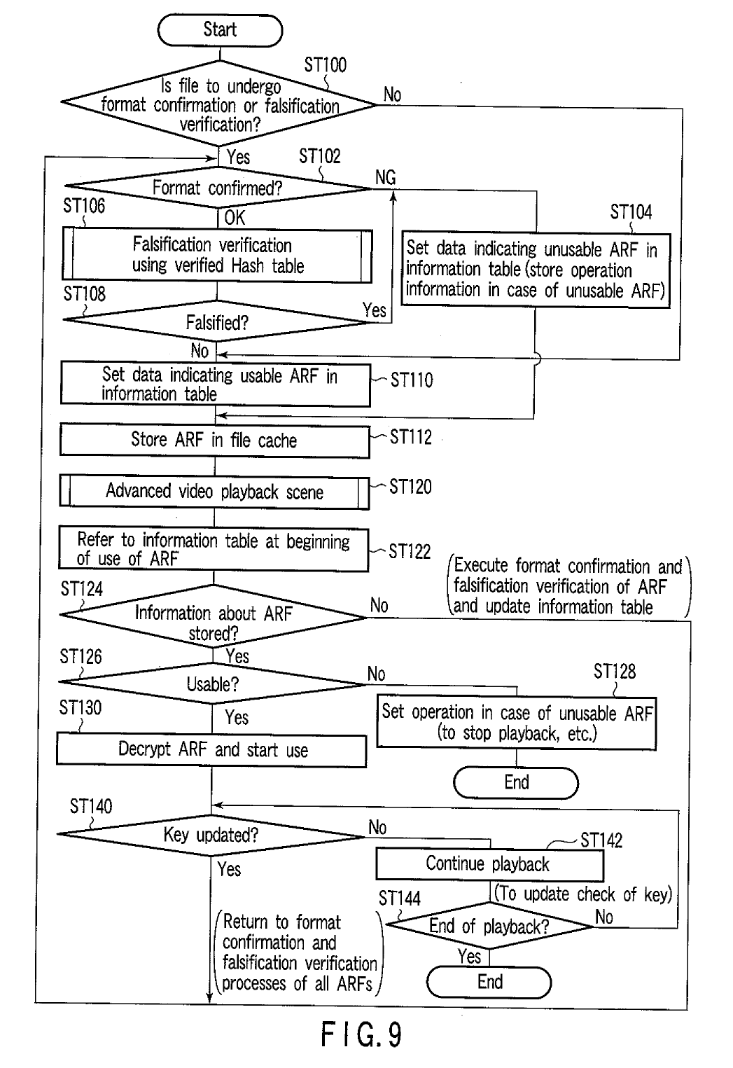

FIG. 9 is a flowchart for explaining an information processing method according to the embodiment of the invention (first embodiment). In Advanced Video, an ARF (Advanced Resource File) protected by access management in the format shown in FIG. 5 can undergo falsification verification using a Hash table which is separately verified. In an Advanced Video player before this invention is achieved, when an ARF protected in the format in FIG. 5 is used, all data of the ARF are read out to execute its format confirmation and Hash value calculations, thus confirming if the calculated Hash values match those stored in a Hash table. However, since this method takes much time, an Advanced Video player according to the embodiment of the invention executes falsification verification upon storing the ARF protected in the format in FIG. 5 in file cache 105.

That is, in the processing shown in FIG. 9, it is checked if a file of interest is a file which needs to undergo format confirmation or that which needs to undergo falsification verification (ST100). If neither format confirmation nor falsification verification are needed (N in ST100), data indicating that the ARF of interest is usable is set in information table 105a (ST110), and that ARF is stored in file cache 105 (ST112). In this example, it is determined based on the presence of, e.g., “protection type” in FIG. 5 that the format confirmation and falsification verification are needed (Y in ST100). If it is not confirmed that the ARF of interest has the format in FIG. 5 (NG in ST102), data indicating that the ARF of interest is unusable is set in information table 105a (ST104), and that ARF is stored in file cache 105 (ST112). In this case (ST104), an operation to be executed when the ARF is unusable is also set in information table 105a (see FIG. 2).

Whether or not the ARF of interest has the format in FIG. 5 can be determined by checking, for example, the FILE_ID and protection type: 12 in FIG. 5, or if format identification information (not shown) in a reserved area corresponds to a file of the format in FIG. 5. If it is confirmed that the ARF of interest has the format in FIG. 5 (OK in ST102), the process advances to a falsification verification process using a Hash table (ST106). In this case, a separately verified Hash table (verified Hash table) is prepared. In the example of FIG. 5, when the Hash pointer after the resource data points to, e.g., Hash value #n in the verified Hash table, whether or not the ARF of interest is falsified can be verified by comparing Hash value SHA1 calculated from the data for Hash and Hash value #n and checking if these two values match.

If it is determined in this verification that the ARF is falsified (Y in ST108), data indicating that the ARF of interest is unusable is set in information table 105a (ST104), and that ARF is stored in file cache 105 (ST112). In this case (ST104), an operation to be executed when the ARF is unusable (an operation which is determined by access management processor 108 and is to be executed when that ARF is going to be used) is also set in information table 105a (see FIG. 2). If it is determined that the ARF is not falsified (N in ST108), data indicating that the ARF of interest is usable is set in information table 105a (ST110), and that ARF is stored in file cache 105 (ST112).

At the beginning of use of the ARF of interest in a playback scene of Advanced Video (ST120), information table 105a shown in FIG. 2 is referred to (ST122). If this table does not include any information about that ARF, for example, if the ARF of interest is file #1, and the table does not describe any usable/unusable information about file #1 (N in ST124), the format confirmation and falsification verification of that ARF are executed (ST102, ST106) to update the contents of information table 105a (ST104, ST110).

If information table 105a includes information about that ARF (Y in ST124), whether or not that ARF is usable is read from the description of that table (ST126). If the ARF of interest is unusable (N in ST126), the operation set when that ARF is unusable (for example, to stop playback if the ARF of interest is file #2 in FIG. 2) is executed (ST128), thus ending the processing of FIG. 9.

If the ARF of interest (for example, file #1 in the example of FIG. 2) is usable (Y in ST126), that ARF is decrypted and begins to be used (ST130). If a key (Title*Key) is updated during Advanced Video playback using this ARF (Y in ST140), the process returns to block ST102 to execute the format confirmation and falsification verification of all ARFs (those which are stored in file cache 105) protected in the format shown in FIG. 5 again. If a key (Title*Key) is not updated (N in ST140), the Advanced Video playback using this ARF is continued (ST142) before the end of playback (N in ST144).

As described above, in this embodiment, before beginning of playback of Advanced Video, an ARF that has undergone the format confirmation/falsification verification is stored in the file cache (ST112). When the ARF protected in the format shown in FIG. 5 begins to be used in a playback scene of Advanced Video, the time needed from when the file is going to be used until it is ready to be used in practice after whether that ARF is usable or unusable is determined can be shortened.

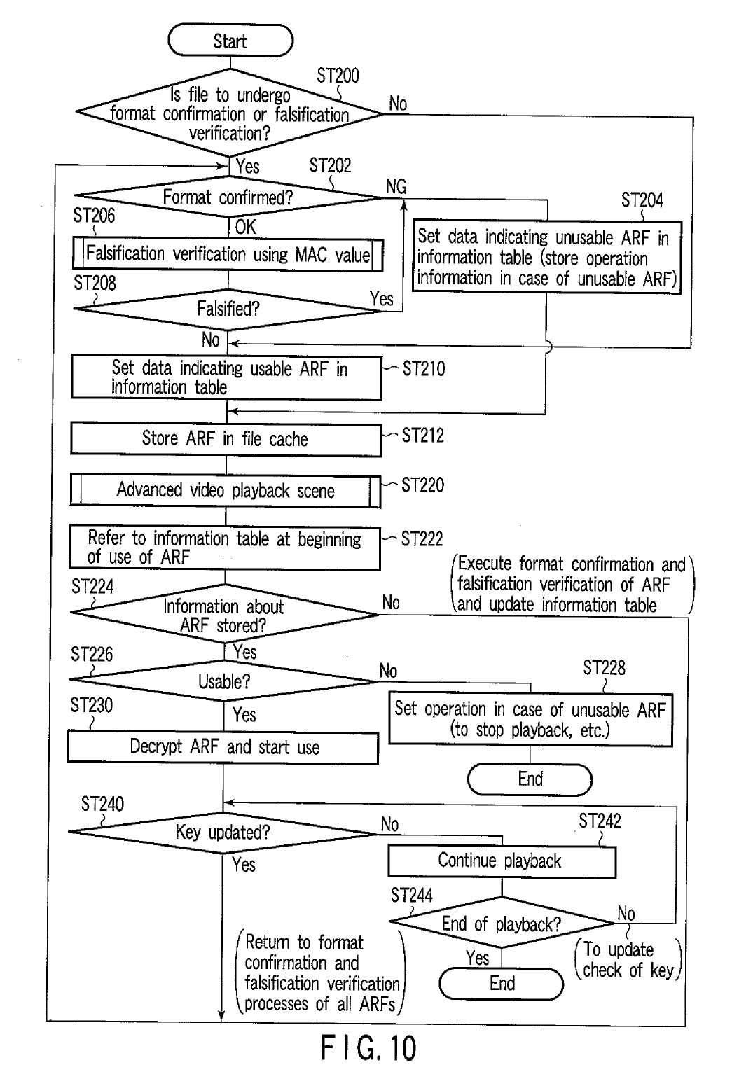

FIG. 10 is a flowchart for explaining an information processing method according to another embodiment of the invention (second embodiment). In Advanced Video, an ARF (Advanced Resource File) protected by access management in the format shown in FIG. 6 can undergo falsification verification using a M*A*C (Message*Authentication*Code) value. In an Advanced Video player before this invention is achieved, when an ARF protected in the format in FIG. 6 is used, all data of the ARF are read out to execute its format confirmation and M*A*C calculation, thus confirming if the calculated M*A*C value matches a M*A*C expected value stored in the ARF. However, since this method takes much time, an Advanced Video player according to the embodiment of the invention executes falsification verification upon storing the ARF protected in the format in FIG. 6 in file cache 105.

That is, in the processing shown in FIG. 10, it is checked if a file of interest is a file which needs to undergo format confirmation or that which needs to undergo falsification verification (ST200). If neither format confirmation nor falsification verification are needed (N in ST200), data indicating that the ARF of interest is usable is set in information table 105a (ST210), and that ARF is stored in file cache 105 (ST212). In this example, it is determined based on the presence of, e.g., “protection type” in FIG. 6 that the format confirmation and falsification verification are needed (Y in ST200). If it is not confirmed that the ARF of interest has the format in FIG. 6 (NG in ST202), data indicating that the ARF of interest is unusable is set in information table 105a (ST204), and that ARF is stored in file cache 105 (ST212). In this case (ST204), an operation to be executed when the ARF is unusable is also set in information table 105a (see FIG. 2).

Whether or not the ARF of interest has the format in FIG. 6 can be determined by checking, for example, the FILE_ID and protection type: 02 in FIG. 6, or if format identification information (not shown) in a reserved area corresponds to a file of the format in FIG. 6. If it is confirmed that the ARF of interest has the format in FIG. 6 (OK in ST202), the process advances to a falsification verification process using a M*A*C value (ST206). In this case, an encrypted Title*Key*File is prepared. In the example of FIG. 6, when the TITLE_KEY_PTR points to, e.g., TITLE*KEY #n in the encrypted Title*Key*File, whether or not the ARF of interest is falsified can be verified by comparing a M*A*C value calculated from TITLE_KEY #n and a M*A*C expected value stored in the ARF and checking if these two values match.

If it is determined in this verification that the ARF is falsified (Y in ST208), data indicating that the ARF of interest is unusable is set in information table 105a (ST204), and that ARF is stored in file cache 105 (ST212). In this case (ST204), an operation to be executed when the ARF is unusable (an operation which is determined by access management processor 108 and is to be executed when that ARF is going to be used) is also set in information table 105a (see FIG. 2). If it is determined that the ARF is not falsified (N in ST208), data indicating that the ARF of interest is usable is set in information table 105a (ST210), and that ARF is stored in file cache 105 (ST212).

At the beginning of use of the ARF of interest in a playback scene of the Advanced Video (ST220), information table 105a shown in FIG. 2 is referred to (ST222). If this table does not include any information about that ARF, for example, if the ARF of interest is file #1, and the table does not describe any usable/unusable information about file #1 (N in ST224), the format confirmation and falsification verification of that ARF are executed (ST202, ST206) to update the contents of information table 105a (ST204, ST210).

If information table 105a includes information about that ARF (Y in ST224), whether or not that ARF is usable is read from the description of that table (ST226). If the ARF of interest is unusable (N in ST226), the operation set when that ARF is unusable (for example, to continue playback by ignoring the file if the ARF of interest is file #3 in FIG. 2) is executed (ST228), thus ending the processing of FIG. 10.

If the ARF of interest (for example, file #1 in the example of FIG. 2) is usable (Y in ST226), that ARF is decrypted and begins to be used (ST230). If a key (Title*Key) is updated during Advanced Video playback using this ARF (Y in ST240), the process returns to block ST202 to execute the format confirmation and falsification verification of all ARFs (those which are stored in file cache 105) protected in the format shown in FIG. 6 again. If a key (Title*Key) is not updated (N in ST240), the Advanced Video playback using this ARF is continued (ST242) before the end of playback (N in ST244).

As described above, in this embodiment, before beginning of playback of Advanced Video, an ARF that has undergone the format confirmation/falsification verification is stored in the file cache (ST212). For this reason, when the ARF protected in the format shown in FIG. 6 begins to be used in a playback scene of the Advanced Video, the time needed from when the file is going to be used until it is ready to be used in practice after whether that ARF is usable or unusable is determined can be shortened.

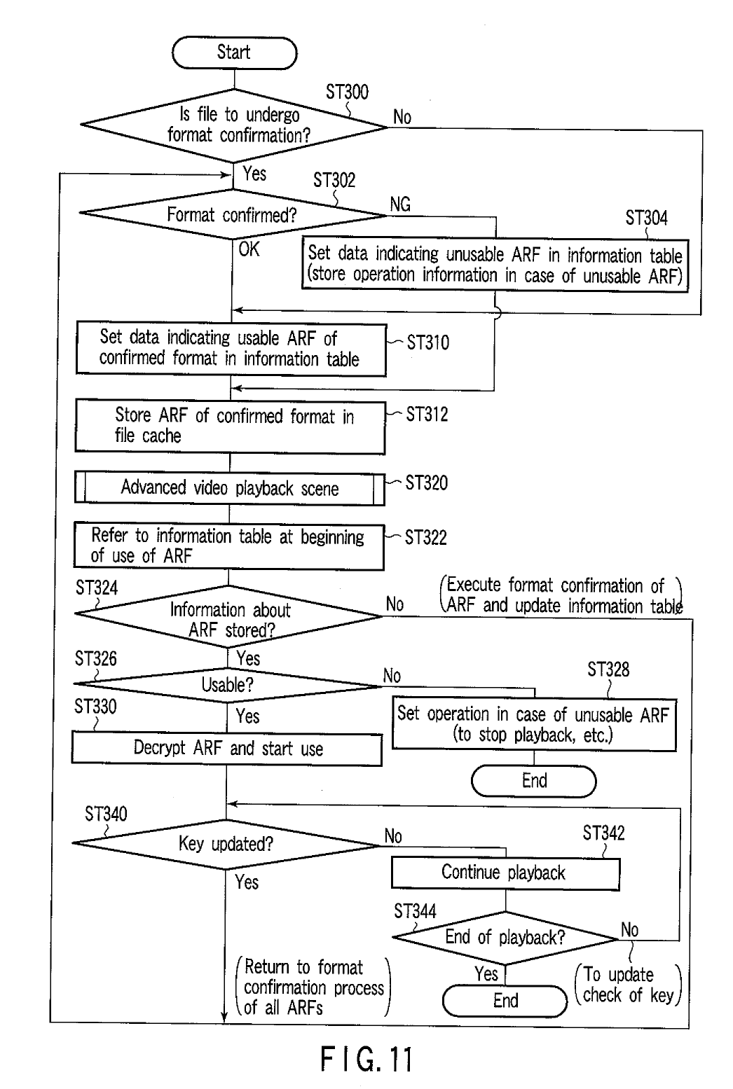

FIG. 11 is a flowchart for explaining an information processing method according to still another embodiment of the invention (third embodiment). In this example, an ARF (Advanced Resource File) protected by access management in the format shown in FIG. 7 is encrypted in the CBC mode for every 16 bytes. Before this invention is achieved, when an ARF protected in the format shown in FIG. 7 is used, all data of that ARF are read out to execute its format confirmation and decryption. However, since this method takes much time, an Advanced Video player according to the embodiment of the invention executes format confirmation when the ARF protected in the format of FIG. 7 is stored in file cache 105.

That is, in the processing shown in FIG. 11, it is checked if a file of interest is a file which needs to undergo format confirmation (ST300). If no format confirmation is needed (N in ST300), data indicating that the ARF of interest is usable is set in information table 105a (ST310), and that ARF (file header and data for decrypt) is stored in file cache 105 (ST312). In this example, it is determined based on the presence of, e.g., “protection type” in FIG. 7 that the format confirmation is needed (Y in ST300). If it is not confirmed that the ARF of interest has the format in FIG. 7 (NG in ST302), data indicating that the ARF of interest is unusable is set in information table 105a (ST304), and that ARF is stored in file cache 105 (ST312). In this case (ST304), an operation to be executed when the ARF is unusable is also set in information table 105a (see FIG. 2).

Whether or not the ARF of interest has the format in FIG. 7 can be determined by checking, for example, the FILE_ID and protection type: 01 in FIG. 7, or if format identification information (not shown) in a reserved area corresponds to a file of the format in FIG. 7. If it is confirmed that the ARF of interest has the format in FIG. 7 (OK in ST302), data indicating that the ARF of interest is usable is set in information table 105a (ST310), and that ARF is stored in file cache 105 (ST312).

At the beginning of use of the ARF of interest in a playback scene of the Advanced Video (ST320), information table 105a shown in FIG. 2 is referred to (ST322). If this table does not include any information about that ARF, for example, if the ARF of interest is file #1, and the table does not describe any usable/unusable information about file #1 (N in ST324), the format confirmation of that ARF is executed (ST302) to update the contents of information table 105a (ST304, ST310).

If information table 105a includes information about that ARF (Y in ST324), whether or not that ARF is usable is read from the description of that table (ST326). If the ARF of interest is unusable (N in ST326), the operation set when that ARF is unusable (for example, to stop playback if the ARF of interest is file #2 in FIG. 2) is executed (ST328), thus ending the processing of FIG. 11.

If the ARF of interest (for example, file #1 in the example of FIG. 2) is usable (Y in ST326), that ARF is decrypted and begins to be used (ST330). If a key (Title*Key) is updated during Advanced Video playback using this ARF (Y in ST340), the process returns to block ST302 to execute the format confirmation of all ARFs (those which are stored in file cache 105) protected in the format shown in FIG. 7 again. If a key (Title*Key) is not updated (N in ST340), the Advanced Video playback using this ARF is continued (ST342) before the end of playback (N in ST344).

As described above, in this embodiment, before beginning of playback of Advanced Video, an ARF that has undergone the format confirmation is stored in the file cache (ST312). For this reason, when the ARF protected in the format shown in FIG. 7 begins to be used in a playback scene of Advanced Video, the time needed from when the file is going to be used until it is ready to be used in practice after whether that ARF is usable or unusable is determined can be shortened. Since decryption in block ST330 can be executed in a unit of a relatively small size, i.e., data for decrypt in FIG. 7, the work memory area used for the decryption of the ARF can be saved.

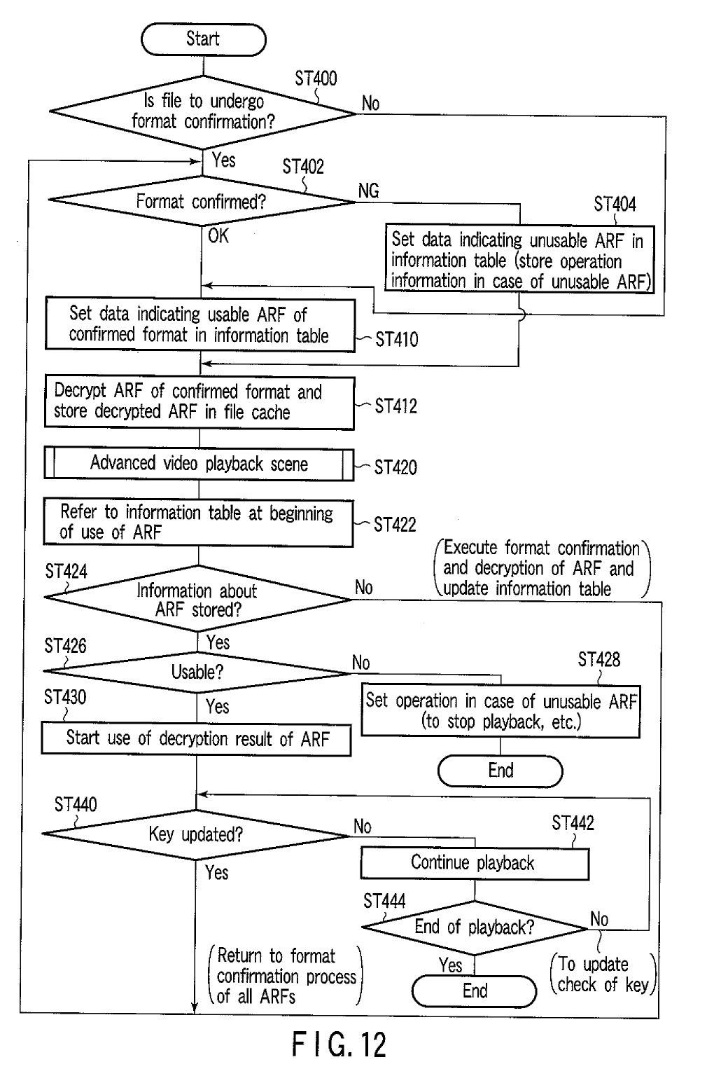

FIG. 12 is a flowchart for explaining an information processing method according to yet another embodiment of the invention (fourth embodiment). In this example, an ARF (Advanced Resource File) protected by access management in the format shown in FIG. 8 is encrypted in the CBC mode for every 16 bytes. Before this invention is achieved, when an ARF protected in the format shown in FIG. 8 is used, all data of that ARF are read out to execute its format confirmation and decryption. However, since this method takes much time, an Advanced Video player according to the embodiment of the invention executes format confirmation when the ARF protected in the format of FIG. 8 is stored in file cache 105.

That is, in the processing shown in FIG. 12, it is checked if a file of interest is a file which needs to undergo format confirmation (ST400). If no format confirmation is needed (N in ST400), data indicating that the ARF of interest is usable is set in information table 105a (ST410), and that ARF is decrypted and is stored in file cache 105 (ST412). In this example, it is determined based on the presence of, e.g., “protection type” in FIG. 8 that the format confirmation is needed (Y in ST400). If it is not confirmed that the ARF of interest has the format in FIG. 8 (NG in ST402), data indicating that the ARF of interest is unusable is set in information table 105a (ST404), and that ARF is stored in file cache 105 (ST412) (in this case, that ARF need not to be decrypted). In this case (ST404), an operation to be executed when the ARF is unusable is also set in information table 105a (see FIG. 2).

Whether or not the ARF of interest has the format in FIG. 8 can be determined by checking, for example, the FILE_ID and protection type: 11 in FIG. 8, or if format identification information (not shown) in a reserved area corresponds to a file of the format in FIG. 8. If it is confirmed that the ARF of interest has the format in FIG. 8 (OK in ST402), data indicating that the ARF of interest is usable is set in information table 105a (ST410), and that ARF is decrypted and is stored in file cache 105 (ST412).

At the beginning of use of the ARF of interest in a playback scene of Advanced Video (ST420), information table 105a shown in FIG. 2 is referred to (ST422). If this table does not include any information about that ARF, for example, if the ARF of interest is file #1, and the table does not describe any usable/unusable information about file #1 (N in ST424), the format confirmation of that ARF is executed (ST402) to update the contents of information table 105a (ST404, ST410).

If information table 105a includes information about that ARF (Y in ST424), whether or not that ARF is usable is read from the description of that table (ST426). If the ARF of interest is unusable (N in ST426), the operation set when that ARF is unusable (for example, to stop playback if the ARF of interest is file #2 in FIG. 2) is executed (ST428), thus ending the processing of FIG. 12.

If the ARF of interest (for example, file #1 in the example of FIG. 2) is usable (Y in ST426), the decryption result of that ARF begins to be used (ST430). If a key (Title*Key) is updated during Advanced Video playback using this ARF (Y in ST440), the process returns to block ST402 to execute the format confirmation of all ARFs (those which are stored in file cache 105) protected in the format shown in FIG. 8 again. If a key (Title*Key) is not updated (N in ST440), the Advanced Video playback using this ARF is continued (ST442) before the end of playback (N in ST444).

As described above, in this embodiment, before beginning of playback of Advanced Video, an ARF that has undergone the format confirmation is stored in the file cache (ST412). When the ARF protected in the format shown in FIG. 8 begins to be used in a playback scene of Advanced Video, the time needed from when the file is going to be used until it is ready to be used in practice after whether that ARF is usable or unusable is determined can be shortened.

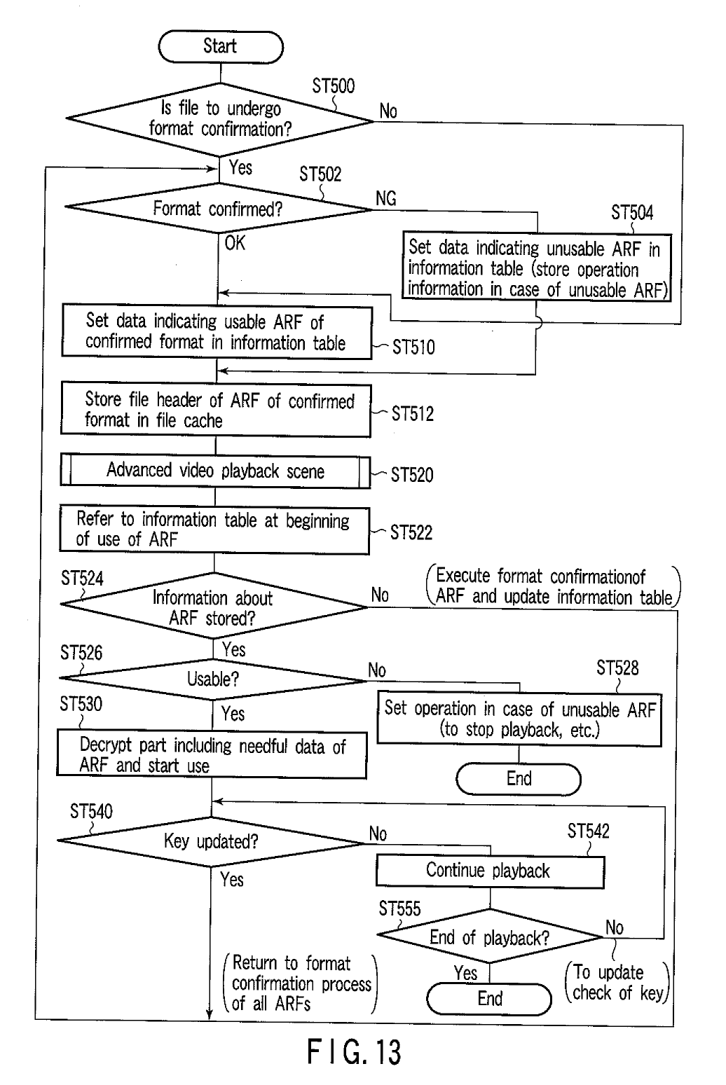

FIG. 13 is a flowchart for explaining an information processing method according to yet another embodiment of the invention (fifth embodiment). This example is also a partial modification of FIG. 11. In this example as well, format confirmation is executed when an ARF protected in the format of FIG. 7 is stored in file cache 105.

That is, in the processing shown in FIG. 13, it is checked if a file of interest is a file which needs to undergo format confirmation (ST500). If no format confirmation is needed (N in ST500), data indicating that the ARF of interest is usable is set in information table 105a (ST510), and the ARF is stored in file cache 105 (ST512). In this example, it is determined based on the presence of, e.g., “protection type” in FIG. 7 that the format confirmation is needed (Y in ST500). If it is not confirmed that the ARF of interest has the format in FIG. 7 (NG in ST502), data indicating that the ARF of interest is unusable is set in information table 105a (ST504), and that ARF is stored in file cache 105 (ST512). In this case (ST504), an operation to be executed when the ARF is unusable is also set in information table 105a (see FIG. 2).

Whether or not the ARF of interest has the format in FIG. 7 can be determined by checking, for example, the FILE_ID and protection type: 01 in FIG. 7, or if format identification information (not shown) in a reserved area corresponds to a file of the format in FIG. 7. If it is confirmed that the ARF of interest has the format in FIG. 7 (OK in ST502), data indicating that the ARF of interest is usable is set in information table 105a (ST510), and the file header of that ARF is stored in file cache 105 (ST512).

At the beginning of use of the ARF of interest in a playback scene of the Advanced Video (ST520), information table 105a shown in FIG. 2 is referred to (ST522). If this table does not include any information about that ARF, for example, if the ARF of interest is file #1, and the table does not describe any usable/unusable information about file #1 (N in ST524), the format confirmation of that ARF is executed (ST502) to update the contents of information table 105a (ST504, ST510).

If information table 105a includes information about that ARF (Y in ST524), whether or not that ARF is usable is read from the description of that table (ST526). If the ARF of interest is unusable (N in ST526), the operation set when that ARF is unusable (for example, to stop playback if the ARF of interest is file #2 in FIG. 2) is executed (ST528), thus ending the processing of FIG. 13.

If the ARF of interest (for example, file #1 in the example of FIG. 2) is usable (Y in ST526), the file header of that ARF is read out from file cache 105, and a part including needful data of the ARF (e.g., one or a predetermined number of 512-byte data blocks as needed) is decrypted, thus beginning its use (ST530). If a key (Title*Key) is updated during Advanced Video playback using this ARF (Y in ST540), the process returns to block ST502 to execute the format confirmation of all ARFs (those which are stored in file cache 105) protected in the format shown in FIG. 7 again. If a key (Title*Key) is not updated (N in ST540), the Advanced Video playback using this ARF is continued (ST542) before the end of playback (N in ST544).

As described above, in this embodiment, before beginning of playback of Advanced Video, the file header of an ARF that has undergone the format confirmation is stored in the file cache (ST512). For this reason, when the ARF protected in the format shown in FIG. 7 begins to be used in a playback scene of Advanced Video, the time needed from when the file is going to be used until it is ready to be used in practice after whether that ARF is usable or unusable is determined can be shortened. Furthermore, since decryption in block ST530 can be executed in a small data unit (e.g., one or a predetermined number of 512-byte data blocks), the memory size used to store its decryption result (or the work memory size used in decryption) can be reduced.

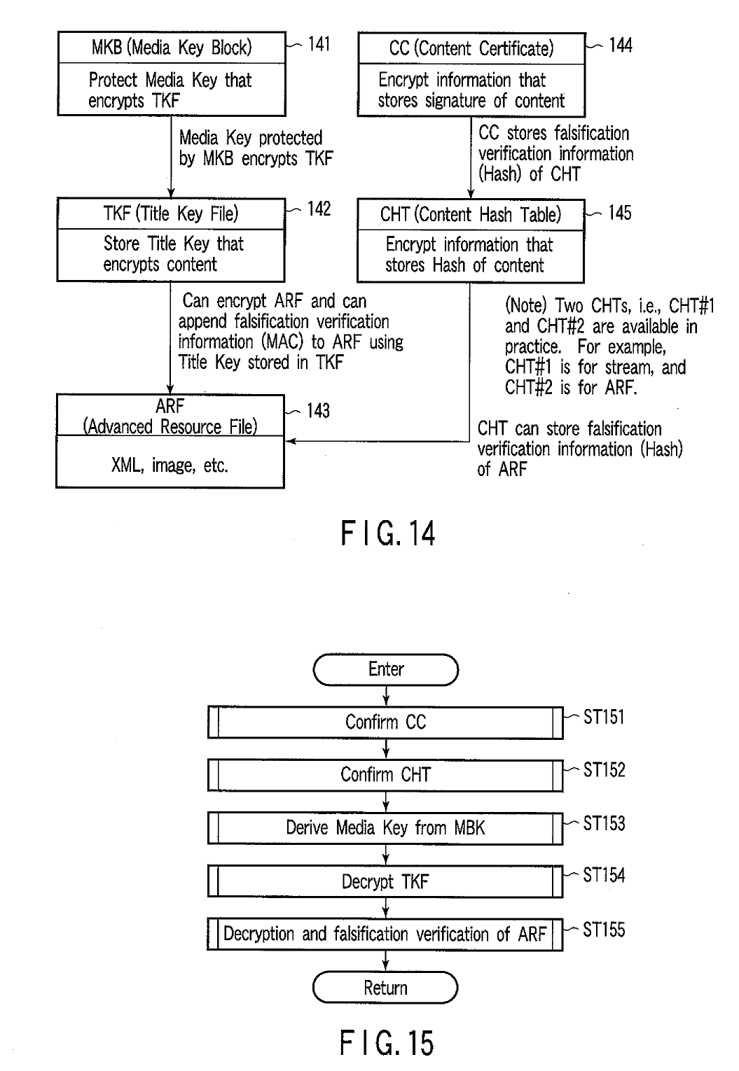

FIG. 14 is a view for explaining the relationship of files associated with falsification verification based on access management. In FIG. 14, M*K*B (Media*Key*Block) 141 provides a scheme for protecting a Media*Key used to encrypt a T*K*F, and the Media*Key protected by M*K*B 141 encrypts the T*K*F. T*K*F (Title*Key*File) 142 stores a Title*Key that encrypts a content. This T*K*F 142 corresponds to the encrypted Title*Key*File in FIG. 6 or 8.

An ARF can be encrypted or falsification verification information (M*A*C, etc.) can be appended to the ARF using the Title*Key stored in T*K*F 142. ARF (Advanced Resource File) 143 corresponds to an XML document, image, and the like included in an advanced content of Advanced Video. CC (Content Certificate) 144 encrypts information that stores a signature of a content, and can store falsification verification information (Hash, etc.) of a CHT.

CHT (Content Hash Table) 145 encrypts information that stores Hash values of a content. Note that two different types of CHTs are available. One CHT is CHT#1 for a data stream (advanced stream in Advanced Video), and the other is CHT#2 for an ARF. CHT#2 which has been verified to be authentic based on the signature of CC 144 or the like corresponds to the verified Hash table in FIG. 5 or 8.

FIG. 15 is a flowchart for explaining an example of falsification verification for an ARF (see FIG. 14). The signature of CC 144 is confirmed (ST151) to confirm that CHT 145 is CHT#2 (ST152). After that, a Media*Key is derived from M*K*B 141 (ST153). Using this Media*Key (based on access management), a T*K*F is decrypted (ST154), and decryption and falsification verification (using M*A*C or Hash) are then executed (ST155).

The falsification verification sequence in FIG. 15 may be used in ARF falsification verification block ST106 in FIG. 9 or ST206 in FIG. 10.

<Points of Embodiments>

1. A player has usable/unusable information (as to whether or not data is determined not to be falsified in falsification verification, whether or not data does not have the corresponding format, and so forth) for each of data stored in a temporary storage device (cache).

2. Falsification verification is executed when data protected using falsification verification data (Hash, M*A*C, etc.) is loaded onto a temporary storage device (cache).

3. Format confirmation is executed when data protected using falsification verification data (Hash, M*A*C, etc.) is loaded onto a temporary storage device (cache).

4. A key to be used is specified using a file header and a field of a given size before a target field of data encrypted in the CBC mode, and the target field is decrypted by acquiring an IV (initial vector).

5. Upon decrypting data encrypted in the CBC mode, a readout file header is held in advance to sequentially read out subsequent data, thus decrypting that data using a file buffer with a fixed size, which is not guaranteed to be larger than the file size of that data.

6. Upon switching a key, the falsification verification of data which has already been stored in the temporary storage device is redone.

<Correspondence Between Embodiments and Invention>

(1) An information processing apparatus, which uses one or more files (ARF: corresponding to files #1 et seq. in FIG. 2) protected in a predetermined format (one of FIGS. 5 to 8), comprises:

an inspection module (110) which inspects whether the one or more files (ARF) is/are usable or unusable;

an information table (105a) in which usable/unusable data of the one or more files (ARF) are set based on the inspection result of the inspection module;

a file cache (105) which stores the one or more files (ARF), the usable/unusable data of which are set in the information table (105a); and

a decryption processor (109) which decrypts the contents (resource data) of an encrypted data object (encrypted P-EVOB) using the one or more files (ARF) stored in the file cache (105) (ST130 to ST530 in FIGS. 9 to 13).

(2) The apparatus further comprises a controller (111), which is configured, when at least one (ARF in FIG. 5 or 6) of the one or more files is protected using falsification verification data (data for Hash or data for M*A*C),

to determine whether or not the at least one file (ARF in FIG. 5 or 6) is falsified, based on the falsification verification data (verified Hash table or M*A*C calculated from a Title*Key) (ST106 in FIG. 9 or ST206 in FIG. 10),

to set, when it is determined that the at least one file is falsified (Y in ST108 or Y in ST208), data indicating that the file (file #2 or #3 in FIG. 2) which is determined to be falsified is unusable in the information table (105a) (ST104 or ST204),

to set, when it is determined that the at least one file is not falsified (N in ST108 or N in ST208), data indicating that the file (file #1 in FIG. 2) which is determined not to be falsified is usable in the information table (105a) (ST110 or ST210), and

to set usable/unusable data of the at least one file (ARF in FIG. 5 or 6) in the information table (105a), and to store the at least one file (ARF in FIG. 5 or 6) in the file cache (105) (ST112 or ST212).

(3) The apparatus further comprises a controller (111), which is configured, when at least one (ARF in FIGS. 5 to 8) of the one or more files is protected using a predetermined format (ARF first to fourth formats),

to confirm whether or not a protection format (protection type in FIGS. 5 to 8) of the at least one file corresponds to the predetermined format (ARF first to fourth formats: protection type=01, 02, 11, or 12) (ST102, ST202, ST302, ST402, or ST502 in FIGS. 9 to 13),

to set, when the protection format of the at least one file does not correspond to the predetermined format (NG in ST102 to NG in ST502), data indicating that the file (file #2 or #3 in FIG. 2), the protection format of which is determined not to correspond to the predetermined format, is unusable in the information table (105a) (ST104 to ST504),

to set, when the protection format of the at least one file corresponds to the predetermined format (OK in ST102 to OK in ST502), data indicating that the file (file #1 in FIG. 2), the protection format of which is determined to correspond to the predetermined format, is usable in the information table (105a) (ST110 to ST510), and

to set usable/unusable data of the at least one file (ARF in FIGS. 5 to 8) in the information table (105a), and to store the at least one file (ARF in FIGS. 5 to 8) in the file cache (105) (ST112 to ST512).

(4) The apparatus is configured so that key information (Title*Key) is used to decrypt the contents (resource data) of the encrypted data object (encrypted P-EVOB), and

when each the one or more files (ARF in FIG. 7) includes a file header including a file identifier (File_ID) and key pointer (Title_KEY_PTR), and resource data (DRD) encrypted in a CBC mode, and the resource data is segmented into data blocks for decrypt, each including an initial vector (IV) and data for output,

the decryption processor (109) specifies the key information (Title*Key) used in the decryption based on the key pointer (Title_KEY_PTR), and decrypts each data block for decrypt by acquiring the initial vector (IV).

(5) The apparatus is configured so that the file cache (105) includes one or more file buffers (105b) of a fixed size (for example, 512 bytes), each of which has a size used to hold the data block for decrypt but is not guaranteed to be larger than a size of the one or more files (ARF in FIG. 7 or 8), and

the resource data (DRD) is decrypted by sequentially storing data parts of the data blocks for decrypt which follow the file header in the file buffers (105b) while holding the file header in the file cache (105).

(6) The apparatus is configured so that key information (Title*Key) is used to decrypt the contents (resource data) of the encrypted data object (encrypted P-EVOB), and the controller (111) is configured to re-set, when the key information (Title*Key) is updated (Y in ST140 to Y in ST540), usable/unusable data of the one or more files (ARF in FIGS. 5 to 8) stored in the file cache (105).

(7) An information processing method, which uses one or more files (ARF) protected in a predetermined format, comprises:

inspecting whether each of the one or more files (ARF) is usable or unusable (ST102, ST108, etc.); setting usable/unusable data of the one or more files (ARF) in an information table (105a) based on the inspection result of an inspection module (ST104, ST110, etc.);

storing, in a file cache (105), the one or more files (ARF), the usable/unusable data of which are set (ST112, etc.); and

decrypting contents (resource data) of an encrypted data object (encrypted P-EVOB) using the stored one or more files (ARF) (ST130 to ST530 in FIGS. 9 to 13).

(8) The method further comprises: when at least one (ARF in FIG. 5 or 6) of the one or more files is protected using falsification verification data (data for Hash or data for M*A*C),

determining whether or not the at least one file (ARF in FIG. 5 or 6) is falsified, based on the falsification verification data (verified Hash table or M*A*C calculated from a Title*Key) (ST106 in FIG. 9 or ST206 in FIG. 10);

setting, when it is determined that the at least one file is falsified (Y in ST108 or Y in ST208), data indicating that the file (file #2 or #3 in FIG. 2) which is determined to be falsified is unusable in the information table (105a) (ST104 or ST204);

setting, when it is determined that the at least one file is not falsified (N in ST108 or N in ST208), data indicating that the file (file #1 in FIG. 2) which is determined not to be falsified is usable in the information table (105a) (ST110 or ST210); and

setting usable/unusable data of the at least one file (ARF in FIG. 5 or 6) in the information table (105a), and storing the at least one file (ARF in FIG. 5 or 6) in the file cache (105) (ST112 or ST212).

(9) The method further comprises: when at least one (ARF in FIGS. 5 to 8) of the one or more files is protected using a predetermined format (ARF first to fourth formats),

confirming whether or not a protection format (protection type in FIGS. 5 to 8) of the at least one file corresponds to the predetermined format (ARF first to fourth formats: protection type=01, 02, 11, or 12) (ST102, ST202, ST302, ST402, or ST502 in FIGS. 9 to 13);

setting, when the protection format of the at least one file does not correspond to the predetermined format (NG in ST102 to NG in ST502), data indicating that the file (file #2 or #3 in FIG. 2), the protection format of which is determined not to correspond to the predetermined format, is unusable in the information table (105a) (ST104 to ST504);

setting, when the protection format of the at least one file corresponds to the predetermined format (OK in ST102 to OK in ST502), data indicating that the file (file #1 in FIG. 2), the protection format of which is determined to correspond to the predetermined format, is usable in the information table (105a) (ST110 to ST510); and

setting usable/unusable data of the at least one file (ARF in FIGS. 5 to 8) in the information table (105a), and storing the at least one file (ARF in FIGS. 5 to 8) in the file cache (105) (ST112 to ST512).

(10) The method is configured so that key information (Title*Key) is used to decrypt the contents (resource data) of the encrypted data object (encrypted P-EVOB), and

when each of the one or more files (ARF in FIG. 7) includes a file header including a file identifier (File_ID) and key pointer (Title_KEY_PTR), and resource data (DRD) encrypted in a CBC mode, and the resource data is segmented into data blocks for decrypt, each including an initial vector (IV) and data for output,

the key information (Title*Key) used in the decryption is specified based on the key pointer (Title_KEY_PTR), and each data block for decrypt is decrypted by acquiring the initial vector (IV).

(11) The method is configured so that when the file cache (105) includes one or more file buffers (105b) of a fixed size (for example, 512 bytes), each of which has a size used to hold the data block for decrypt but is not guaranteed to be larger than a size of the one or more files (ARF in FIG. 7 or 8),

the resource data (DRD) is decrypted by sequentially storing data parts of the data blocks for decrypt which follow the file header in the file buffers (105b) while holding the file header in the file cache (105).

(12) The method is configured so that key information (Title*Key) is used to decrypt the contents (resource data) of the encrypted data object (encrypted P-EVOB), and is configured to re-set, when the key information (Title*Key) is updated (Y in ST140 to Y in ST540), usable/unusable data of the one or more files (ARF in FIGS. 5 to 8) stored in the file cache (105).

<Effects of Embodiments>

According to one embodiment of the invention, in processing of data of a protected file (ARF),

a) in a scene using data which is protected using falsification verification data and has a huge size, falsification verification of that data is executed in advance, thus shortening a time needed from when a player is going to use that data until that data is ready to use in practice;

b) in a scene that plays back huge data protected by CBC encryption, the data can be decrypted and played back using a buffer having a size smaller than the file size of the data, thereby reducing the size of a work memory needed for a decryption processor; and

c) in a scene that uses only a part of huge data protected by CBC encryption, only the part to be used of that data can be decrypted and played back, thus shortening a time needed from when a player is going to use that part of the data until that part of the data is ready to use in practice.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus configured to use at least one file protected in a predetermined format, comprising:
an inspection module configured to inspect whether the file is available or unavailable;
an availability information data generation module configured to generate an information table of availability information of the file based on an output of the inspection module;
a file cache configured to store the file and the information table; and
a decryption processor configured to decrypt contents of an encrypted data object using the file stored in the file cache.

2. The apparatus of claim 1, further comprising a controller, when the file is protected using falsification verification data, the controller is configured to determine whether or not the at least one file is falsified, based on the falsification verification data, to set data indicating that the file is not available in the information table when it is determined that the file is falsified, to set data indicating that the file is available in the information table when it is determined that the file is not falsified, to set availability information of the file in the information table, and to store the file in the file cache.

3. The apparatus of claim 1, further comprising a controller, when at least one of the one or more files is protected using a predetermined format, the controller is configured to confirm whether or not a protection format of the file corresponds to the predetermined format, to set data indicating that the file is unavailable in the information table when the protection format of the file does not corresponds to the predetermined format, to set data indicating that the file is available in the information table when the protection format of the file corresponds to the predetermined format, to set availability information data of the file in the information table, and to store the file in the file cache.

4. The apparatus of claim 1, wherein the file comprises a file header indicative of a file identifier and a key pointer, and resource data encrypted in a Cipher-block chaining(CBC) mode, and the resource data is segmented into data blocks, each comprising an initial vector and data for output, and the decryption processor is configured to specify key information to be used in the decryption based on the key pointer, and to decrypt each data block by acquiring the initial vector, when the key information is used to decrypt the contents of the encrypted data object.

5. The apparatus of claim 4, wherein the file cache comprises at least one file buffer of a fixed size, the size of the file buffer is large enough to hold the data blocks, and
the resource data is decrypted by sequentially storing data sections of the data blocks in the file buffers while holding the file header in the file cache.

6. The apparatus of claim 2, wherein key information is used to decrypt the contents of the encrypted data object, and the controller is configured to update the availability information data of the file stored in the file cache when the key information is updated.

7. An information processing method, which uses at least one file protected in a predetermined format, comprising:
inspecting whether the file is available or unavailable;
generating the availability information data of the file in an information table based on an output of the inspection;
storing the file and the availability information data of the file in a file cache; and
decrypting contents of an encrypted data object using the stored file.

8. The method of claim 7, further comprising:
when at least one file is protected using falsification verification data,
determining whether or not the file is falsified, based on the falsification verification data;
setting data indicating that the file is not available in the information table when it is determined that the file is falsified;
setting data indicating that the file is available in the information table when it is determined that the file is not falsified;
setting the availability information data of the file in the information table; and
storing the file in the file cache.

9. The method of claim 7, further comprising:
when the file is protected using a predetermined format,
confirming whether or not a protection format of the file corresponds to the predetermined format;
setting data indicating that the file is not available in the information table when the protection format of the file does not correspond to the predetermined format;
setting data indicating that the file is available in the information table when the protection format of the file corresponds to the predetermined format;
setting availability information data of the file in the information table; and
storing the file in the file cache.

10. The method of claim 7, wherein, when key information is used to decrypt the contents of the encrypted data object, the file comprises a file header containing a file identifier, a key pointer, and resource data encrypted in a CBC mode and segmented into data blocks for decrypt, each comprising an initial vector and data for output, and
the key information used in the decryption is specified based on the key pointer, and each data block is decrypted by acquiring the initial vector.

11. The method of claim 10, wherein when the file cache comprises at least one file buffer of a fixed size, the size of the file buffer is large enough to hold the data block, and
the resource data is decrypted by sequentially storing data sections of the data blocks in the file buffers while holding the file header in the file cache.

12. The method of claim 8, wherein key information is used to decrypt the contents of the encrypted data object and the availability information data of the file stored in the file cache is updated when the key information is updated.
